(19) United States
(12) Patent Application Publication
(10) Pub. No.: US 2026/0335876 A1
(43) Pub. Date: Oct. 29, 2026

(54) RECYCLING OF WASTE SOLID IONOMER COMPONENTS

(71) Applicant: Johnson Matthey Public Limited Company, London (GB)

(72) Inventors: Denis DUCHESNE, Woodbury, MN (US); Ross John GORDON, Reading (GB); Gareth HART, Reading (GB)

(21) Appl. No.: 19/491,163

(22) PCT Filed: Jul. 23, 2024
(86) PCT No.: PCT/GB2024/051937

§ 371 Date: Dec. 8, 2025

Related U.S. Application Data
(60) Provisional application No. 63/516,152, filed on Jul. 28, 2023.

(30) Foreign Application Priority Data
Aug. 9, 2023 (GB) 2312187.4
Sep. 15, 2023 (GB) 2314101.3

(51) Int. Cl. B01J 49/53; B01J 39/05; B01J 39/20; B09B 3/80; B09B 101/15; C08J 11/06; C08L 27/18; C08L 29/10; H01M 8/008

(52) U.S. Cl. CPC B01J 49/53; B01J 39/05; B01J 39/20; B09B 3/80; C08J 11/06; C08L 27/18; C08L 29/10; H01M 8/008; B09B 2101/15; C08J 2327/18; C08J 2329/10; C08L 2203/20; C08L 2205/02; C08L 2207/20

(57) ABSTRACT

A method of forming an ionomer blend during a process of recycling waste solid ionomer material, the method comprising: heating the waste solid ionomer material in a solvent to disperse the waste solid ionomer material; and mixing ionomer from the waste solid ionomer material with a second ionomer material to co-mingle ionomer from the waste solid ionomer material with ionomer from the second ionomer material forming a co-mingled ionomer blend during the process of recycling the waste solid ionomer material.

### FIELD

This specification relates to recycling of waste solid ionomer components/materials such as ionomer membranes, catalyst coated ionomer membranes, and/or ionomer containing catalyst layers used in fuel cells and hydrogen producing water electrolysers.

### BACKGROUND

Fuel cell and hydrogen producing water electrolyser production is set for rapid growth as investment is placed into the global hydrogen economy. Catalyst coated membranes (CCMs) are a major functional component of both fuel cells and electrolysers. Such CCMs generally comprise a conductive polymer membrane coated on either side by a catalyst containing layer. The CCMs are configured to drive oxidation and reduction reactions and support proton and electron transport, these processes been required for the fuel cell and electrolyser technologies to function.

While variations in CCM component materials and configurations exist according to functional performance requirements in end use applications, they generally contain several components of value including one or more platinum group metal (PGM) catalysts and one or more proton conducting polymers.

Typically, the membrane is formed of one or more ionomers such as perfluorosulfonic-acid (PFSA) ionomers. Ionomer may also be provided in one or both of the catalyst layers. The ionomer in the catalyst layers may be the same or different to the ionomer in the main membrane component and/or in other catalyst layer(s). The membrane may also include a reinforcement layer for mechanical durability, such as polytetrafluoroethylene (PTFE).

A CCM may comprise two different catalysts, one for driving an oxidation reaction on one side of the CCM and one for driving a reduction reaction on the other side of the CCM. A CCM may also comprise a recombination catalyst which is provided to catalyse the recombination of hydrogen and oxygen to form water, reducing the quantity of hydrogen crossing the membrane and mixing with oxygen to form a potentially explosive mixture. A CCM may also include a multivalent cation delivered as a salt or oxide (supported or unsupported) as a peroxide scavenger, e.g., a metal oxide such as CeO₂.

CCM catalysts can be based on platinum group metals such as platinum, ruthenium, iridium, palladium, or mixtures thereof. The platinum group metals may be provided in elemental (metallic) form, in compound form (e.g., an oxide, such as an iridium oxide catalyst), or as a PGM-base metal alloy (e.g., PtCo). Furthermore, the PGM catalyst materials may be supported on a substrate material, such as a carbonaceous substrate material (e.g., carbon, such as a platinum-on-carbon catalyst comprising particles of carbon on which platinum is disposed or PtCo-on-carbon, or an organic material, e.g., nanostructured thin film catalyst (NTFC) technology as described in US2020102659 and WO2006089180). The CCM catalyst may contain an ionomer as part of its formulation.

Catalyst coated membranes (CCMs) can also be provided in combination with additional functional layers to form multi-layer membrane electrode assemblies (MEAs). Such MEAs may have 3, 5, or 7 layers for example.

With the increase in CCM manufacture for fuel cells and electrolysers, there is an associated increase in CCM waste materials, including a significant volume of scrap material created during CCM manufacture (e.g., due to failure at quality control) and also an increase in end-of-life (EoL) CCMs. Since CCMs contain several components which are rare and/or valuable, including platinum group metals (notably Pt, Pd, Ir and Ru) and ionomer (both in the membrane and catalyst layers), there is a growing demand for methods of recycling such components from waste CCM materials.

One current method to recover PGMs from production scrap and end-of-life CCM material involves incineration. The incineration process yields a PGM rich (typically Pt and Ir) ash which is processed via conventional PGM refining routes. However, the incineration process releases harmful and toxic gases such as CO₂ and HF from the polymers that are part of the membrane. Both these gases have negative impacts as they pollute the atmosphere, increase the greenhouse effect, and/or have harmful effects in the human body. As such, there is a need for a cleaner process which reduces or eliminates the emission of these gases.

In addition to the above, the incineration method destroys the ionomer component which also has significant value. As such, it would also be desirable to provide a process which is capable of recovering ionomer components as well as providing a process which is cleaner, safer, and more environmentally friendly.

Processes for recovering perfluorosulfonic acid ionomer from solid ionomer membranes are known. See, for example, WO2016/156815, U.S. Pat. No. 7,255,798, and WO2021250576. Such methods involve heating solid ionomer membranes in a solvent to disperse the ionomer. Solvents may include water, aqueous solutions (e.g., water and a base), organic solvents, or mixtures thereof such as mixtures of alcohols and water. The resultant ionomer dispersions can then be re-used to manufacture new membranes.

To enable fuel cells and electrolysers to become more sustainable technologies, there remains a need for commercially viable and environmentally friendly routes to recycle ionomer membranes from waste CCM materials including production scrap and end-of-life material. It is an aim of the present specification to address this problem.

### SUMMARY

Different types of ionomers are currently being used to manufacture membranes for fuel cells and electrolysers. For example, ionomer membranes can differ in their molecular weight, ionomer equivalent weight, and/or comprise ionomer with differing sulfonated side chains. It has also been proposed to blend ionomers of different types in order to fabricate membranes with adjusted properties.

One problem with recycling of waste ionomer materials such as manufacturing scrap and used ionomer materials is that the materials may not have the desired compositions or properties for re-use in new applications such as new fuel cells and electrolysers. Another problem is that manufacturing scrap and used ionomer materials may have a variety of different types and compositions which are required to be recycled into new materials which meet target specifications for re-use in new applications. Yet another problem is ensuring that any recycling process for waste ionomer materials should be flexible, energy efficient, and cost effective.

The present inventors have realized that the aforementioned problems can be addressed by integrating an ionomer blending process into a recycling process for waste ionomer materials in order to adjust the compositions and properties of the waste ionomer materials during recycling to meet target specifications for re-use in new applications.

According to the present specification there is provided a method of forming an ionomer blend during a process of recycling waste solid ionomer material, the method comprising:
heating the waste solid ionomer material in a solvent to disperse the waste solid ionomer material; and
mixing ionomer from the waste solid ionomer material with a second ionomer material to co-mingle ionomer from the waste solid ionomer material with ionomer from the second ionomer material forming a co-mingled ionomer blend during the process of recycling the waste solid ionomer material.

The present inventors have considered that when recycling scrap or used ionomer membranes of different ionomer types, the different types of membranes could be separately dispersed by heating in solvent and then the independently dispersed ionomers could then be mixed to form an ionomer blend. The ionomer blend can then be used to fabricate a new ionomer membrane with target properties controlled according to the type and proportions of the blended ionomers.

One or more high temperature dispersal steps may be followed by one or more mixing steps to form a blended, co-mingled ionomer composition which exhibits properties between those of the parent membranes as may be predicted.

The present inventors have further realized that the high temperature processes required to reliably disperse and then blend ionomer dispersions is similar to the high temperature dispersion processes they use to disperse scrap or used ionomer membrane materials as part of a recycling process. Ionomer membrane materials include ionomer membranes, catalyst coated ionomer membranes, and catalyst layer materials comprising ionomer. The present inventors have realized that rather than independently dispersing membranes using multiple high temperature dispersion processes and then one or more further mixing processes to form a blend, an ionomer blend can be produced directly during the waste membrane dispersion step of the recycling process. That is, rather than dispersing the membrane and then subsequently performing another high temperature dispersion process later to form a blend, an ionomer membrane can be mixed with other types of membrane or ionomer material prior to the waste membrane dispersal process during recycling such that a blend is directly achieved during the waste membrane dispersal and recycling process.

Accordingly, the present specification also provides a method of forming an ionomer blend directly from waste solid ionomer material, the method comprising: mixing a first waste solid ionomer material with a second ionomer material in a solvent; and heating the mixture to disperse the first waste solid ionomer material and co-mingle ionomer from the first waste solid ionomer material with ionomer from the second ionomer material in the solvent to directly form a co-mingled ionomer blend during the step of dispersing the first waste solid ionomer material. The first waste solid ionomer material can be an ionomer membrane, a catalyst-coated ionomer membrane, or a catalyst layer material containing ionomer. Accordingly, following the previously described method, the waste solid ionomer material is mixed with the second ionomer material prior to heating the waste solid ionomer material in the solvent to disperse the waste ionomer material such that as the waste solid ionomer material is dispersed in the solvent, the ionomer from the waste solid ionomer material mixes with the second ionomer material to co-mingle ionomer from the waste solid ionomer material with ionomer from the second ionomer material forming the co-mingled ionomer blend during the step of heating the waste solid ionomer material in the solvent to disperse the waste ionomer material. Most preferably, the waste ionomer material in solid form is mixed with the second ionomer material which is also in solid form prior to dispersing the solid ionomer mixture in a single dispersion step to form the co-mingled ionomer blend. That is, the blend forms from solid starting materials during the step of dispersing the waste ionomer material such that only a single heating/dispersing step is required. Such a method does not require separate dispersion of the second ionomer material and integrates the dispersion of all the ionomer materials into the dispersion step which is required already for processing of waste ionomer material.

The methodology described in the present specification is advantageous for several reasons:
it enables ionomer membrane materials to be recycled into new membrane components with modified and/or optimized compositions and properties through predictive blending;
it provides greater flexibility to enable recycling of ionomer membrane materials of different types and compositions to produce new membrane components which meet target specifications;
it provides flexibility to blend ionomers from different membrane materials and/or to blend ionomer from scrap or used membrane materials with virgin/fresh ionomer material during recycling;
it ensures that the different ionomers are properly co-mingled at a molecular level as part of the recycling process; and
it can achieve the ionomer blending in an energy efficient manner by integrating the ionomer blending step into a membrane material dispersal step as part of the membrane recycling process thus reducing costs, additional equipment requirements, and improving environmental impact.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows an example of a membrane recycling process in which scrap/used membranes formed of different ionomers are mixed and dispersed to form a target blend of the ionomers, the blend then being used to fabricate new catalyst-coated membranes comprising the target blend of ionomers and having associated target properties;

FIG. 2 shows a variant of FIG. 1 in which the scrap/used membranes are first converted to salt form (e.g., via treatment with a metal hydroxide solution) prior to dispersion of the membranes to form the blend of ionomers and use of the blend to fabricate new catalyst-coated membranes having target compositions and properties;

FIG. 3 shows another variant in which a scrap/used ionomer membrane is mixed with a dispersion of a different type of ionomer (rather than mixing with a different type of solid membrane) prior to dispersion of the membrane to form the blend of ionomers and use of the blend to fabricate new catalyst-coated membranes;

FIG. 4 shows another variant in which a first membrane comprising a first ionomer is mixed with a second membrane comprising both the first ionomer and a second ionomer such that new membranes fabricated from the resultant blend will comprise both ionomers but with a different target ratio of first and second ionomer;

FIG. 5 shows another variant in which a catalyst-coated membrane containing a first ionomer is mixed with a membrane containing a second ionomer and subjected to a high temperature dispersion process to form a blend, in which case solid catalyst materials can be separated from the solvent mixture (e.g., via filtration) prior to using the blend to fabricate new membrane and/or catalyst layers as part of a catalyst coated membrane manufacturing process;

FIG. 6 shows a similar variant to FIG. 5 with the difference that the catalyst-coated membrane to be recycled contains two different ionomers 1 and 2 and it is desired to change the ratio of ionomers 1 and 2 when recycling the membrane into a new membrane product;

FIGS. 7(a) and (b) show ¹⁹F NMR of different ionomer dispersions: (a) from bottom to top traces are 100% of ionomer 1 (SSC), 75% ionomer 1 and 25% ionomer 2 (LSC), 50% of ionomer 1 and 2, 25% ionomer 1 and 75% ionomer 2, and 100% ionomer 2; (b) a peak at −145.5 ppm is present in ionomer 2 but not in ionomer 1 and the intensity of this peak in the different ionomer blends follows a rule-of-mixtures (note that the NMR spectra were normalised to a peak with the same integration for all samples);

FIG. 8 shows a picture of the different ionomer dispersions (20-25 wt %)—from left to right dispersions are 100% of ionomer 1, 75% ionomer 1 and 25% ionomer 2, 50% of ionomer 1 and 50% ionomer 2, 25% ionomer 1 and 75% ionomer 2, and 100% ionomer 2;

FIG. 9 shows the variable-temperature dynamic mechanical analysis data of the blended ionomer membranes: membrane containing 100% of LSC, blend containing 25% of LSC and 75% SSC, blend containing 50% of each LSC and SSC, blend containing 75% of LSC and 25% of SSC, and the membrane containing 100% of SSC (T_{α} is determined by the maximum tan δ); and

FIG. 10 shows the in-plane proton conductivity at 70° C. (solid lines) and at 40° C. (dashed lines) as a function of relative humidity for ionomer 2, 50:50 blend of ionomer 1 and 2, and ionomer 1.

### DETAILED DESCRIPTION

As described in the summary section, the present specification provides a method of forming an ionomer blend during a process of recycling waste solid ionomer material, the method comprising:
heating the waste solid ionomer material in a solvent to disperse the waste solid ionomer material; and
mixing ionomer from the waste solid ionomer material with a second ionomer material to co-mingle ionomer from the waste solid ionomer material with ionomer from the second ionomer material forming a co-mingled ionomer blend during the process of recycling the waste solid ionomer material.

Furthermore, according to certain preferred methods, the waste solid ionomer material is mixed with the second ionomer material prior to heating the waste solid ionomer material in the solvent to disperse the waste ionomer material such that as the waste solid ionomer material is dispersed in the solvent, the ionomer from the waste solid ionomer material mixes with the second ionomer material to co-mingle ionomer from the waste solid ionomer material with ionomer from the second ionomer material forming the co-mingled ionomer blend during the step of heating the waste solid ionomer material in the solvent to disperse the waste ionomer material.

For example, a method of forming an ionomer blend directly from solid recycled ionomer material can be provided, the method comprising: mixing a first solid recycled ionomer material with a second ionomer material in a solvent; and heating the mixture to disperse the first solid recycled ionomer material and co-mingle ionomer from the first solid recycled ionomer material with ionomer from the second ionomer material in the solvent to directly form a co-mingled ionomer blend during the step of dispersing the first solid recycled ionomer material.

The waste solid ionomer material can be an ionomer membrane, a catalyst-coated ionomer membrane, or a catalyst layer material containing ionomer and is hereinafter referred to generally as an ionomer membrane material. For example, the waste solid ionomer material can be a scrap or used solid ionomer membrane material from a fuel cell or electrolyser application.

The membrane material is typically formed of a fluorinated polymer comprising a fluorinated polymer backbone chain and a plurality of groups represented by formula —SO₃Z, wherein Z is hydrogen or a cation, optionally a metal cation or a quaternary ammonium cation. Commercially available perfluorosulfonic acid (PFSA) membranes and dispersions exhibit variations in ionic equivalent weight (Equivalent weight EW=grams ionomer/mol SO₃H) and side chain lengths. Some examples of different PFSA ionomers are given below.

### C2 Side Chain (SSC):

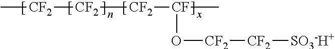

### C4 Side Chain:

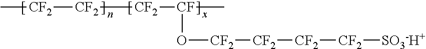

### Long Side Chain (LSC):

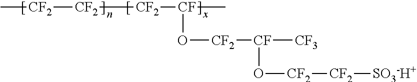

Previous work had reported that a membrane produced by independently dispersing and subsequently mixing different ionomers to form a blended ionomer does not exhibit properties intermediate between those of the parent ionomer membranes as may be predicted. See, for example, C. Zaluski and G. Xu, “Blends of Nafion and Dow Perfluorosulfonated Ionomer Membranes”, Macromolecules 1994, 27, 6750-6754. However, the present work has found that by properly dispersing waste ionomer components at high temperatures it is possible to ensure that the different ionomers are properly co-mingled at a molecular level so that a membrane formed from such an ionomer blend will have predictable properties intermediate to those of the blended components. Furthermore, the blending process can be integrated into a membrane dispersal step as part of a membrane recycling process.

It should be noted that the second ionomer material is a physically separate and distinct material to the first waste solid ionomer material and is physically mixed with the waste solid ionomer material during the present process rather than, for example, being an integral ionomer component of the waste solid ionomer material. The ionomer in the second ionomer material can thus be different to the ionomer in the first solid ionomer membrane material and may have a different molecular weight, a different equivalent weight, and/or different sulfonated side chains. The second ionomer material is either in solid or dispersed form in the solvent prior to heating the mixture. The second ionomer material may comprise fresh, unused ionomer or may itself be a scrap membrane material (e.g., a scrap membrane, a scrap catalyst-coated membrane, or a scrap catalyst layer) which is to be recycled in conjunction with the first waste ionomer membrane material. In the latter case, the second ionomer material can be a solid ionomer membrane material of a different type to the first waste solid ionomer membrane material. One or more further ionomer materials can also be mixed in the solvent with the first waste solid ionomer material and the second ionomer material prior to heating. The proportions of the first waste solid ionomer material, the second ionomer material, and if present the one or more further ionomer materials, are selected and controlled to achieve a target composition for the co-mingled ionomer blend after heating. The composition can be tuned according to predictive blending to achieve a target specification for new membrane materials fabricated from the recycled ionomer materials. The mixture of different ionomer materials and solvent may comprise an ionomer solids content of: at least 2 wt %, 5 wt %, 10 wt %, or 15 wt %; no more than 50 wt %, 40 wt %, 30 wt %, 25 wt %, or 20 wt %; or within a range defined by any combination of the aforementioned lower and upper limits. The solvent can be water, an aqueous salt solution, an organic solvent, an alcohol, or a mixture thereof, e.g., a mix of alcohol and water.

For the integrated dispersal and blending step, the mixture may be heated to a temperature of: at least 150° C., 180° C., 200° C., 220° C., 230° C., or 240° C.; no more than 400° C., 300° C., 275° C., or 250° C.; or within a range defined by any combination of the aforementioned lower and upper limits. Furthermore, the mixture can be heated for: at least 15 minutes, 30 minutes, 1 hour, 2 hours, or 3 hours; no more than 72 hours, 48 hours, 24 hours, 10 hours, 6 hours, or 4 hours; or within a range defined by any combination of the aforementioned lower and upper limits. Heating in this manner drives disentanglement of ionomer aggregates such that different ionomer types can comingle. The process can be performed in an autoclave and may be performed at elevated pressure and/or under a controlled (e.g., inert) atmosphere.

In addition to the above, one or both of the first waste solid ionomer material and the second ionomer material may be converted to salt form prior to heating. This can be achieved using a base such as NaOH, a metal carbonate, or an ammonium hydroxide or carbonate. In this case, after heating the co-mingled ionomer blend can be converted back to protonated acid form (via ion exchange).

The co-mingled ionomer blend can then be used to manufacture a new membrane, catalyst coated membrane, or catalyst layer for a fuel cell or electrolyser.

The present specification thus provides a method of preparing blended ionomer by dispersion processes to obtain co-mingled blended ionomer product from recycled membrane materials. Membrane components containing an ionomer type can be blended with those of different ionomer types to generate a co-mingled ionomer product. The ionomer membranes may include used or virgin ionomer solid and may include addition of ionomer dispersion to the recycling process. The recycling process will disperse the ionomers from the solid form (membrane or solid) or dispersion such that a true blend is generated during the dispersion process rather than a mixture of discrete ionomer domains which can be generated by simply mixing two ionomer dispersions prior to casting a membrane.

Generation of comingled ionomer dispersions is thus achieved using the high temperature dispersion process as used in ionomer recycling to generate a blended ionomer product, such as a solid, dispersion or membrane, with predicted performance based on composition and method of dispersion. A benefit of producing a comingled ionomer blend via the dispersion process as used to recycle ionomer from membrane, catalyst-coated membrane, or catalyst layers is that the properties of a membrane or catalyst layer will exhibit the desired performance as predicted through design via the blending process. It has been demonstrated that while a comingled ionomer dispersion is not always produced by simply mixing ionomer dispersions together prior to casting a membrane, the present high temperature dispersion process can enable properly comingled ionomer blends to be achieved. Furthermore, forming the correct blend of ionomers prior to carrying out the high temperature recycling process negates the requirement for a subsequent high temperature dispersion process to form a blend prior to casting a membrane.

### EXAMPLES

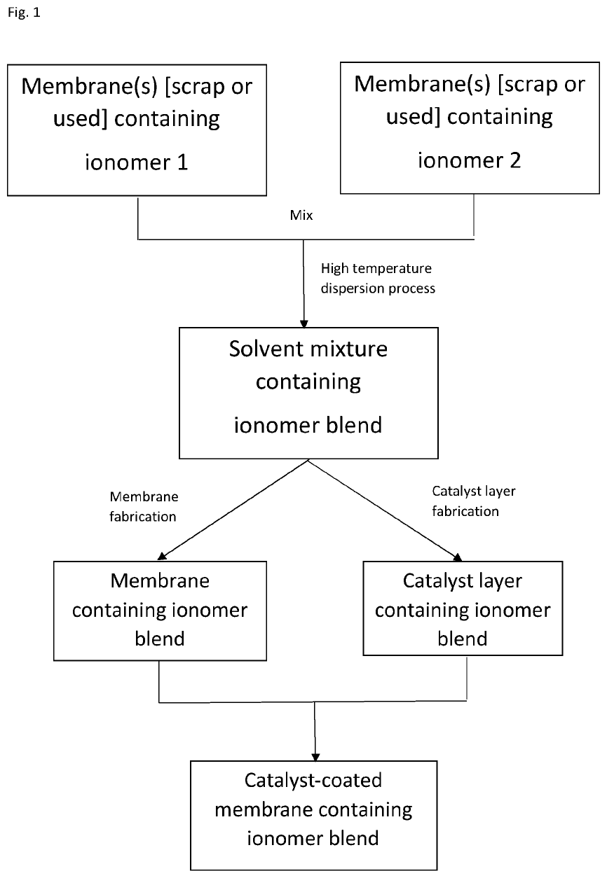

To scrap membrane containing ionomer 1 (1.27 g) and scrap membrane containing ionomer 2 (1.17 g) was added deionised water (77.45 g). The mixture was heated in a glass liner within an autoclave under an inert atmosphere of nitrogen to a maximum temperature of 237.1° C. (where the system remained at this temperature for 3 hours) and left to cool to room temperature. The resultant ionomer blend can then be used to fabricate new membrane and/or catalyst layers as part of a catalyst coated membrane manufacturing process. FIG. 1 shows an example of this process flow.

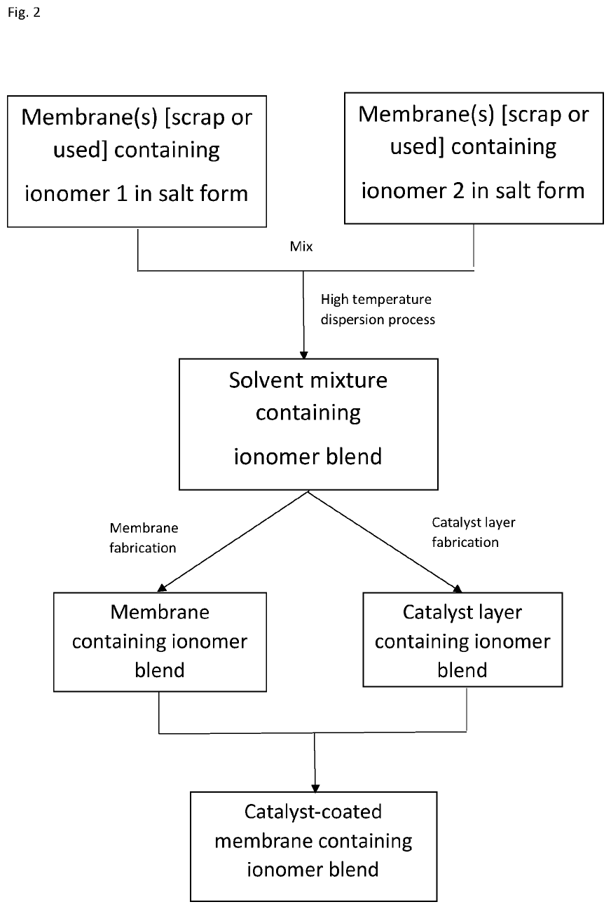

Various modifications to the process flow shown in FIG. 1 can be made. The process flow shown in FIG. 2 is a variant in which the membranes are first converted to salt form. This may be achieved by treating the membranes in a basic solution (e.g., an aqueous metal hydroxide solution) to convert the sulfonic acid groups of the ionomers to salt form. This can be achieved without dispersal of the membranes (e.g., by not raising the temperature to a point at which the membranes disperse). The salt form of each membrane can be mixed and subjected to a high temperature dispersion process to form a solvent mixture containing an ionomer blend. The ionomer blend can then be used to fabricate new membrane and/or catalyst layers as part of a catalyst coated membrane manufacturing process noting that the salt form of the ionomers can be converted back to protonated acid form (via ion exchange) as part of this process.

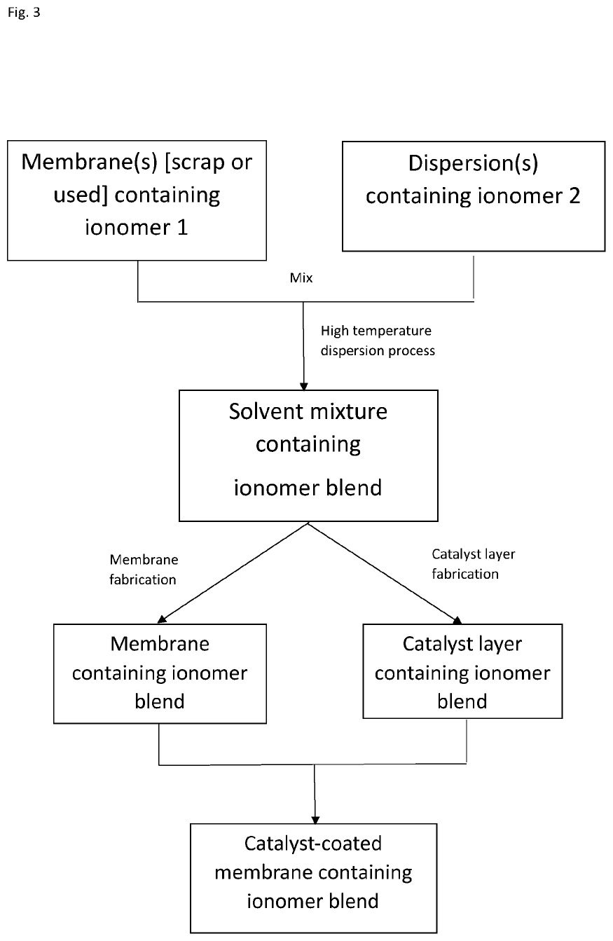

FIG. 3 shows another variant in which a scrap or used ionomer membrane is mixed with a dispersion of a different type of ionomer rather than mixing with a different type of solid membrane as in the previous examples. Ionomer in either or both of the membrane and dispersion may be in salt form as described in relation to the example of FIG. 2 or in protonated acid form as in the example of FIG. 1. The mixture of ionomer membrane and ionomer dispersion is heated to disperse the membrane and intermingle the ionomer from the membrane and dispersion to form a blend. As before, the ionomer blend can then be used to fabricate new membrane and/or catalyst layers as part of a catalyst coated membrane manufacturing process.

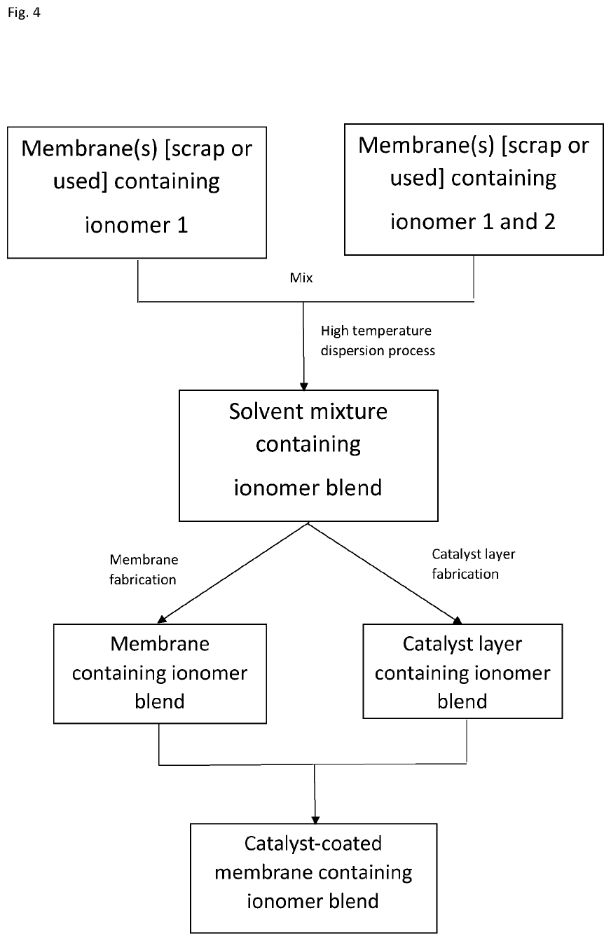

FIG. 4 shows another variant in which a first membrane comprising ionomer 1 is mixed with a second membrane comprising both ionomer 1 and a different ionomer 2. This approach can be used if it is desired to fabricate a new membrane component comprising both ionomer 1 and ionomer 2, but where it is desired to increase the amount of ionomer 1 in the composition relative to ionomer 2. As before, the mixture of membranes is subjected to a high temperature dispersion process in order to disperse the membranes and inter-mingle the ionomers to form a blend which can then be used to fabricate new membrane and/or catalyst layers as part of a catalyst coated membrane manufacturing process.

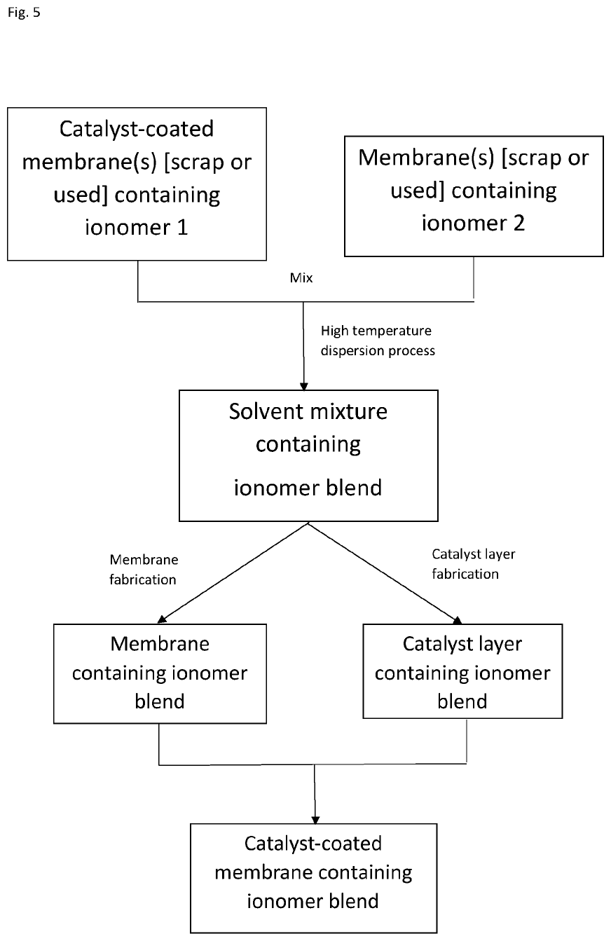

FIG. 5 shows another variant in which a catalyst coated membrane containing ionomer 1 is mixed with a membrane containing ionomer 2 and subjected to a high temperature dispersion process to form a solvent mixture comprising an ionomer blend. In this case, solid catalyst materials can be separated from the solvent mixture (e.g., via filtration). The ionomer blend can then be used to fabricate new membrane and/or catalyst layers as part of a catalyst coated membrane manufacturing process.

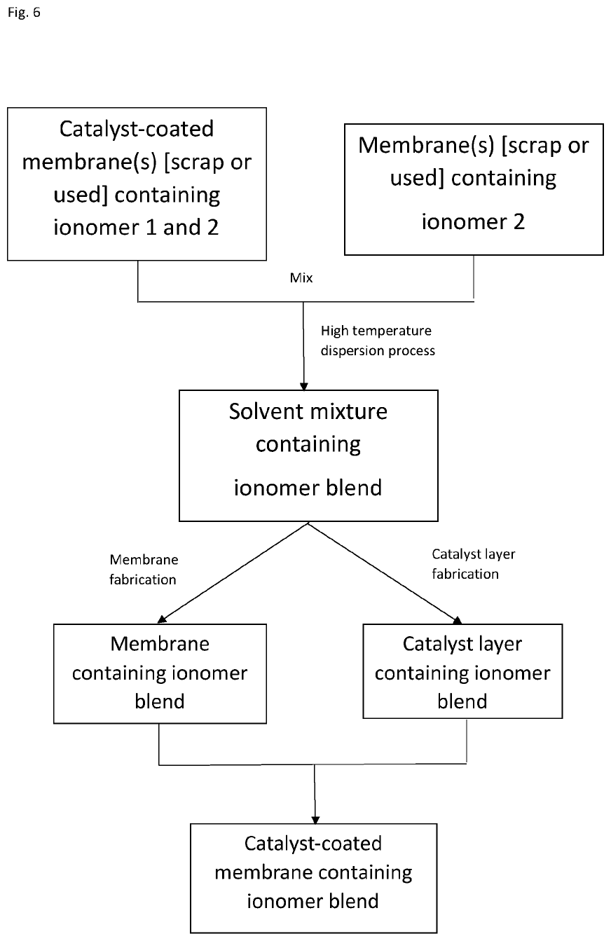

FIG. 6 shows a similar variant to FIG. 5 with the difference that the catalyst-coated membrane contains two different ionomers 1 and 2. In this case, it is desired to fabricate a new membrane which includes a higher proportion of ionomer 2. As such, the catalyst-coated membrane is mixed with a membrane containing ionomer 2 in a suitable proportion to achieve a desired target ratio of ionomer 1 to ionomer 2.

### Blended Ionomer Dispersion Preparation

To 15 g of membrane (containing either LSC or SSC ionomer) was added deionised water (400 mL) and lithium hydroxide (0.58 g). For the blends, either 11.25 g, 7.5 g or 3.75 g of LSC-containing membrane was mixed with SSC-containing membrane to make a total weight of 15 g. The mixture was heated in a PTFE liner within an autoclave under an inert atmosphere of nitrogen to a maximum temperature of 240° C. (where the system remained at this temperature for 3 hours) and then left to cool to room temperature. The resultant ionomer dispersion was filtered through a Whatman™ 541 to separate the PTFE residue. The ionomer-containing filtrate was then converted back to the sulfonic acid form via an ion-exchange process. An Omnifit glass column was packed with Amberlyst™ 15 (H) resin then treated with three bed volumes of water, three bed volumes of 3M hydrochloric acid, and three bed volumes of deionised water. Then the ionomer dispersion was injected into the column at a flow rate of one bed volume per hour. Amberlyst™ 15 (H) is commercially available from Thermo Scientific Chemicals (CAS number 39389-20-3). ICP-OES analysis confirmed the removal of lithium (<1 ppm). The acidic ionomer dispersion was then freeze-dried to obtain the ionomer as a solid powder.

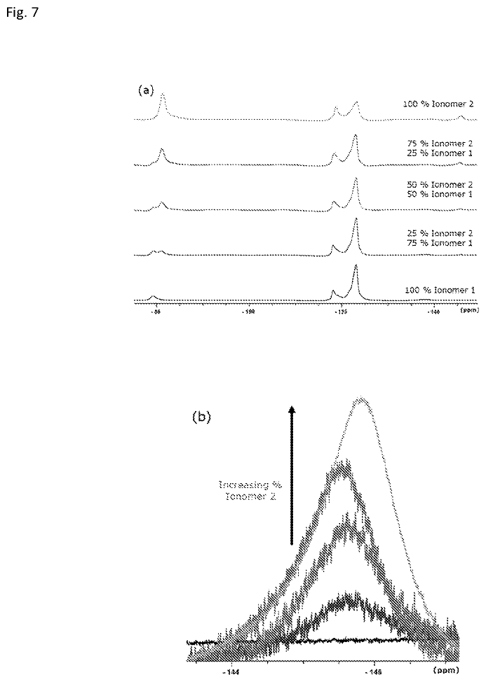

¹⁹F NMR analysis (FIG. 7) of the LSC and SSC ionomer dispersions revealed a distinct peak present in the LSC spectrum that was absent in the SSC spectrum. This peak at −145.5 ppm was assigned to the side-chain CF group. Normalising the spectra to the peak assigned to the side-chain SF₂ group (present in all samples in a similar quantity as the equivalent weight EW is similar) we observed a linear trend for the intensity of the peak at −145.5 ppm. The intensity increases with increasing amount of LSC present in the blended ionomer dispersion.

### Membrane Preparation

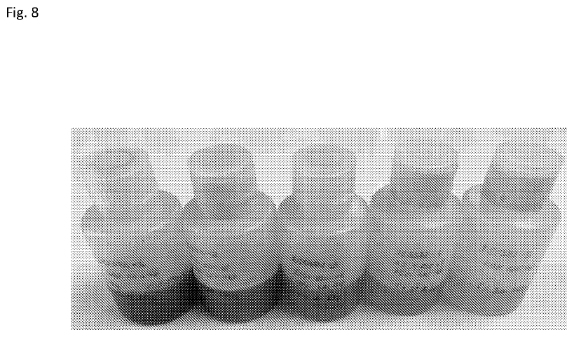

The freeze-dried ionomers and ionomer blends were added to 70 wt % ethanol solvent (remaining balance water) at a total of 20-25 wt % ionomer solids. The resulting mixtures were placed on a roller mixer at 60 rpm for 24 hrs to obtain homogenous dispersions (shown in FIG. 8). Approximately 2 mL of ionomer dispersion was coated on to a 75 μm thick Kapton™ polyimide backing film using a Elcometer™ 4340 motorised film applicator and steel coating knife. Coating was performed at 20° C. then the solvent was left to evaporate for 10 mins. The ionomer-coated Kapton™ film was placed in an oven at 100° C. for 10 mins to evaporate the residual solvent, then subsequently placed in another oven to anneal at 160° C. for 12 mins.

### Dynamic Mechanical Analysis

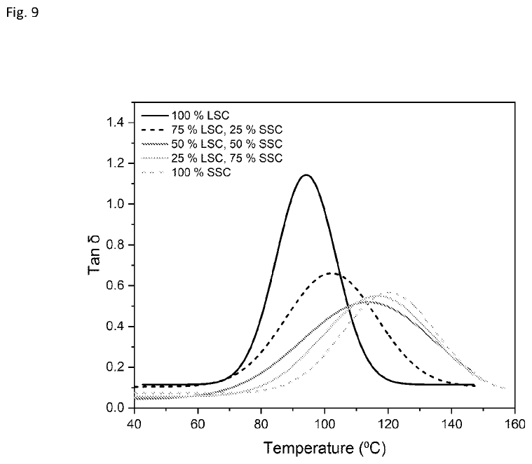

For the dynamic mechanical analysis measurements, the ionomer membranes were peeled off the Kapton™ backing film. The final ionomer membrane thickness was measured using a Fischer MMS Inspection DFT magnetic induction thickness gauge. All membranes were between 15-20±2 μm thick. A TA Instruments dynamic mechanical analyser, Discovery DMA 850, equipped with a film tension clamp and standard furnace unit was used to carry out the thermomechanical measurements. A 7×40 mm strip of membrane was clamped in the DMA film tension clap at a gage length of 6.8-7.2 mm. The tan δ vs. temperature curves for the membranes containing either 100% LSC or SSC, and the different ionomer blends (75:25, 50:50, 25:75) are shown in FIG. 9. The equivalent weight (EW) for the two different side-chain ionomers (LSC 769 EW and SSC 790 EW) is similar but the side-chain length differs. The single ionomer membranes show distinct thermomechanical transitions (T_{α=}95° C. for the 769 EW LSC and T_{α=}121° C. for the 790 EW SSC). The blended ionomer membranes also display a single alpha transition, instead of two distinct transitions, this suggests the membranes are composed of a molecularly mixed ionomer blend. Further, the T_{α} follows a linear trend with the different blends, the alpha transition increases with a higher content of the SSC ionomer. The table below shows the transition data for the different ionomer films and blended ionomer membranes.

| LSC % (769 EW) | SSC % (790 EW) | T_{α} (°C) | Tan δ |
|---|---|---|---|
| 100 | 0 | 95 | 1.14 |
| 75 | 25 | 102 | 0.66 |
| 50 | 50 | 112 | 0.51 |
| 25 | 75 | 116 | 0.55 |
| 0 | 100 | 121 | 0.57 |

### Proton Conductivity Measurements

A Scribner 740 MTS equipped with an Iviumstat was used to carry out the proton conductivity measurements. A 10×30 mm strip of membrane on Kapton™ backing was clamped in to an in-plane measurement cell head. The cell was then placed in a thermo-controlled humid chamber to monitor the membrane resistance at different temperatures (40-70° C.) and relative humidities (30-80%). The in-plane proton conductivity (σ_{∥}) could be calculated from the following equation:

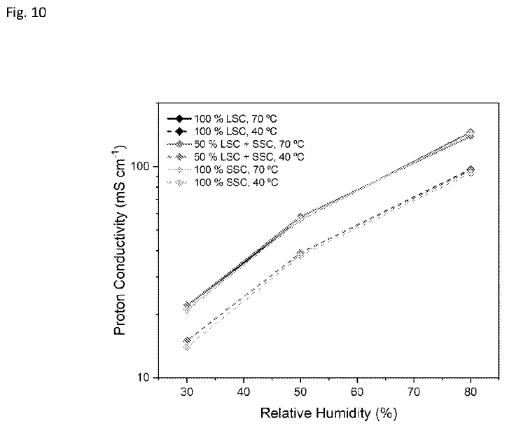

σ_{∥}=d/(tlR)

where d is the distance between the two platinum electrodes, R is the measured membrane resistance, t is the thickness of the membrane, and l is the width of the membrane. Proton conductivity usually increases with increasing temperature and humidity. This was the case for single ionomer membranes and the blended ionomer membranes (see FIG. 10). The proton conductivities were not significantly altered with ionomer composition. As the EW is similar for the two different side-chain ionomers, the proton conductivity should be similar. The table below shows the proton conductivity measurements of the two different ionomer and a 50:50 blend at different temperatures and relative humidities (RH).

| | Proton Conductivity (mS cm⁻¹) | | | | | |
|---|---|---|---|---|---|---|
| | 40 °C | | | 70 °C | | |
| | 30% | 50% | 80% | 30% | 50% | 80% |
| Sample | RH | RH | RH | RH | RH | RH |
| 100% LSC | 15 | 39 | 97 | 22 | 56 | 145 |
| 50% LSC and SSC | 15 | 39 | 96 | 22 | 58 | 139 |
| 100% SSC | 14 | 38 | 93 | 21 | 56 | 144 |

The aforementioned examples represent a non-exhaustive set of variants. It will be appreciated that while this invention has been particularly shown and described with reference to certain examples, it will be understood to those skilled in the art that various changes in form and detail may be made without departing from the scope of the invention as defined by the appended claims.

1. A method of forming an ionomer blend during a process of recycling waste solid ionomer material, the method comprising:
heating the waste solid ionomer material in a solvent to disperse the waste solid ionomer material; and
mixing ionomer from the waste solid ionomer material with a second ionomer material to co-mingle ionomer from the waste solid ionomer material with ionomer from the second ionomer material forming a co-mingled ionomer blend during the process of recycling the waste solid ionomer material,
wherein the waste solid ionomer material is mixed with the second ionomer material prior to heating the waste solid ionomer material in the solvent to disperse the waste ionomer material such that as the waste solid ionomer material is dispersed in the solvent, the ionomer from the waste solid ionomer material mixes with the second ionomer material to co-mingle ionomer from the waste solid ionomer material with ionomer from the second ionomer material forming the co-mingled ionomer blend during the step of heating the waste solid ionomer material in the solvent to disperse the waste ionomer material, and
wherein the second ionomer material is in solid form in the solvent prior to heating the waste solid ionomer material.

2. (canceled)

3. The method according to claim 1,
wherein the waste solid ionomer material is an ionomer membrane, a catalyst-coated ionomer membrane, or a catalyst layer material containing ionomer.

4. The method according to claim 1,
wherein the waste solid ionomer material is manufacturing scrap or used ionomer material from a fuel cell or electrolyser application.

5. The method according to claim 1,
wherein the waste solid ionomer material is formed of a fluorinated polymer comprising a fluorinated polymer backbone chain and a plurality of groups represented by formula —SO₃Z, wherein Z is hydrogen or a cation, optionally a metal cation or a quaternary ammonium cation.

6. The method according to claim 1,
wherein the ionomer in the second ionomer material is different to the ionomer in the waste solid ionomer material.

7. The method according to claim 6,
wherein the ionomer in the second ionomer material has a different molecular weight, a different equivalent weight, and/or different sulfonated side chains than the ionomer in the waste solid ionomer material and/or comprises fresh, unused ionomer.

8. (canceled)

9. The method according to claim 1,
wherein the second ionomer material is a solid ionomer material of a different type to the waste solid ionomer material, optionally an ionomer membrane, a catalyst-coated ionomer membrane, or a catalyst layer material containing ionomer.

10. The method according to claim 1,
wherein one or more further ionomer materials are mixed with the ionomer from the waste solid recycled ionomer material and the ionomer from the second ionomer material to form the co-mingled ionomer blend.

11. The method according to claim 1,
wherein the proportions of the waste solid ionomer material, the second ionomer material, and if present the one or more further ionomer materials, are selected and controlled to achieve a target composition for the co-mingled ionomer blend after heating.

12. The method according to claim 1,
wherein, during heating, the solvent comprises an ionomer solids content of: at least 2 wt %, 5 wt %, 10 wt %, or 15 wt %; no more than 50 wt %, 40 wt %, 30 wt %, 25 wt %, or 20 wt %; or within a range defined by any combination of the aforementioned lower and upper limits.

13. The method according to claim 1,
wherein the solvent is water, an aqueous salt solution, an organic solvent, an alcohol, or a mixture thereof.

14. The method according to claim 1,
wherein the waste solid ionomer material is heated in the solvent to a temperature of: at least 150° C., 180° C., 200° C., 220° C., 230° C., or 240° C.; no more than 400° C., 300° C., 275° C., or 250° C.; or within a range defined by any combination of the aforementioned lower and upper limits.

15. The method according to claim 1,
wherein the waste solid ionomer material is heated in the solvent for: at least 15 minutes, 30 minutes, 1 hour, 2 hours, or 3 hours; no more than 72 hours, 48 hours, 24 hours, 10 hours, 6 hours, or 4 hours; or within a range defined by any combination of the aforementioned lower and upper limits.

16. The method according to claim 1,
wherein one or both of the waste solid ionomer material and the second ionomer material are converted to salt form prior to forming the co-mingled ionomer blend.

17. The method according to claim 16,
wherein after forming the co-mingled ionomer blend it is converted back to protonated acid form.

18. The method according to claim 1,
wherein the co-mingled ionomer blend is used to manufacture a new membrane, catalyst-coated membrane, or catalyst layer for a fuel cell or electrolyser.
